(19) United States
(12) Patent Application Publication
(10) Pub. No.: US 2023/0054968 A1
(43) Pub. Date: Feb. 23, 2023

(54) DELIVERY OF MOBILE LOCKER CABINETS LOADED WITH POSTAL ITEMS AND COL-LECTION OF EMPTY MOBILE LOCKER CABINETS

(71) Applicant: Ford Global Technologies, LLC, Dearborn, MI (US)

(72) Inventors: Bas van den Heuvel, Limburg (NL); Mark Gijbels, Vlaams-brabant (BE); Dwi Gross, Aachen (DE); Friedrich Peter Wolf-Monheim, Aachen (DE)

(73) Assignee: Ford Global Technologies, LLC, Dearborn, MI (US)

(21) Appl. No.: 17/821,056

(22) Filed: Aug. 19, 2022

(30) Foreign Application Priority Data
Aug. 20, 2021 (DE) 102021121606.0

(51) Int. Cl. B60P 3/00; B60P 1/64

(52) U.S. Cl. CPC B60P 3/007; B60P 1/649

(57) ABSTRACT

The invention relates to a method for delivering mobile locker cabinets loaded with postal items to automatic parcel stations and for collecting empty mobile locker cabinets from automatic parcel stations by means of a delivery vehicle having a cargo space. In order to reduce the outlay associated with logistics of locker cabinets and thus to reduce the associated costs of logistics, depending on a delivery route, the locker cabinets loaded with postal items are arranged in a delivery sequence within the cargo space in such a way that a locker cabinet which forms a start of the delivery sequence and a locker cabinet which forms an end of the delivery sequence are accessible directly via a rear loading/unloading opening (8) of the cargo space.

### CROSS-REFERENCE TO RELATED APPLICATIONS

The applications claims priority to and the benefit of German Application No. 102021121606.0, filed Aug. 20, 2021, which is hereby incorporated by reference herein in its entirety.

### FIELD

The invention relates to a method for delivering mobile locker cabinets loaded with postal items and collect empty mobile locker cabinets.

### BACKGROUND

Automatic parcel stations offer high efficiency for the entire process of post or parcel delivery. In this way, a customer can choose not to have a parcel ordered by them delivered to their home but to be delivered to an automatic parcel station, from where they can pick up the package at will. An important advantage for the delivery company is that the success rate in the delivery of parcels is much higher since it does not depend on the customer being at home at the time of delivery. Moreover, the delivery companies can deliver several parcels at the same time to the same automatic parcel station.

However, this is still a very laborious process for the delivery person, who must first sort the parcels in the delivery vehicle, pick them up and carry them to the automatic parcel station, open/program the automatic parcel station and place the parcels in their individual lockers of locker cabinets of the automatic parcel station. This process requires a lot of time and effort.

As a possible solution, there has been a proposal for mobile locker cabinets which are automatically loaded with parcels at a main hub of a delivery company. The mobile locker cabinets loaded with the parcels are then transported to the automatic parcel stations. One advantage is that all the parcels contained in a locker cabinet can be delivered to a location in one go. Thus, a single delivery vehicle and a single delivery person can deliver more parcels per day than with the conventional delivery method.

However, one problem connected to this is how to ensure an efficient process for transporting the mobile locker cabinets. The logistics of several heavy mobile locker cabinets on board a delivery vehicle can be a challenge. Moreover, an efficient process is required for unloading and delivering mobile locker cabinets loaded with parcels to automatic parcel stations and for collecting empty locker cabinets from automatic parcel stations. Among other things, there is also a problem with regard to the efficiency of the handling of full and empty locker cabinets during a delivery and collection process.

US 2017 / 0 291 766 A1 relates to a delivery vehicle for delivering, in particular autonomously, consignments to different locations along a delivery route. The delivery vehicle has a cargo space with a shelf system. The shelf system is designed to receive shelves in a plurality of storage positions for holding the shelves ready and in at least one removal position for removing consignments from the shelves. The shelf system has at least one adjustment device for adjusting, in particular sliding, the shelves of the shelf system in each case between a plurality of storage positions and the at least one removal position.

US 2019 / 0 130 349 A1 relates to a mobile locker cabinet system for collecting/delivering parcels at different locations. A mobile locker cabinet can travel automatically to a location to facilitate parcel collection/delivery. Moreover, the mobile locker cabinet system can expand the capacity of a stationary automatic parcel station which is monitored when the number of available lockers of the automatic parcel station falls below a predetermined threshold capacity. In response thereto, a mobile locker cabinet is automatically directed to the automatic parcel station in order to increase the number of available lockers of the automatic parcel station.

WO 2020 / 148 022 A1 relates to a logistics system for shipping items by means of a vehicle. The system has an item supply system, which is designed to be transported in the vehicle, a data management system, which is designed to link at least one item, which is present in at least one position in the item supply system, to at least one item of information from at least one customer order, and is designed to link all the components of the logistics system and at least one external input or output device to one another and in an interactive manner. Depending on the at least one item of information of the at least one customer order, the at least one position in the item supply system of the at least one item can be changed, and so the at least one item is stored removably in the item supply system. Moreover, the data management system is designed to always have available a current state of the at least one item of information of the at least one customer order.

DE 10 2016 010 688 A1 relates to a system for loading or unloading a transport vehicle. The system has at least one shelf module, which has a plurality of shelf levels arranged one above the other for receiving objects, a mobile transport unit, which is external to the vehicle, for transporting the shelf module, and a movement unit for the shelf module, which is arranged in the cargo space of the transport vehicle.

### SUMMARY

The invention includes a method for delivering mobile locker cabinets loaded with postal items to automatic parcel stations and for collecting empty mobile locker cabinets from automatic parcel stations by means of a delivery vehicle having a cargo space. Moreover, the invention includes to a system for delivering mobile locker cabinets loaded with postal items to automatic parcel stations and for collecting empty mobile locker cabinets from automatic parcel stations, having at least one delivery vehicle having a cargo space for accommodating mobile locker cabinets and a plurality of mobile locker cabinets for accommodating postal items.

Here and in the following, the term postal item is not intended to be restrictive but to include all items which can be handled by delivery companies. Even if it is parcels which are predominantly dealt with below, other postal items, such as letters, should also be included.

The underlying object of the invention is to reduce an outlay associated with logistics of locker cabinets and thus the associated costs of logistics.

According to the invention, the object is achieved by a method having the features of disclosure, according to which, depending on a delivery route, the locker cabinets loaded with postal items are arranged in a delivery sequence within the cargo space in such a way that a locker cabinet which forms a start of the delivery sequence and a locker cabinet which forms an end of the delivery sequence are accessible directly via a rear loading/unloading opening of the cargo space.

It should be noted that the features and measures presented individually in the following description can be combined with one another in any technically feasible manner and indicate further embodiments of the invention. The description additionally characterizes and specifies the invention, in particular in conjunction with the figures.

According to the invention, a delivery vehicle, in particular a utility vehicle, is loaded in a special manner with locker cabinets which are loaded with postal items, in particular parcels, in order to facilitate the delivery of these full locker cabinets to automatic parcel stations and the collection of empty locker cabinets from automatic parcel stations. In particular, the locker cabinets loaded with postal items are arranged in the cargo space of the delivery van in a delivery sequence which is defined by a delivery route, which can be optimized in respect of the travel distances between the automatic parcel stations in order to minimize the delivery route, for example. Since the start of the delivery route is accessible directly via the rear loading/unloading opening of the cargo space, the locker cabinet forming this start can be removed directly and easily from the cargo space in order to be delivered to an automatic parcel station. Removing the locker cabinet from the cargo space makes available in the cargo space a space for accommodating an empty locker cabinet in the cargo space. The locker cabinets arranged between the start and the end of the delivery sequence are arranged in a corresponding cabinet row within the cargo space.

According to an advantageous embodiment, after removal of a locker cabinet to be delivered immediately from the cargo space, the remaining locker cabinets located in the cargo space are moved in the cargo space in such a way, while maintaining the delivery sequence, that the locker cabinet to be delivered next assumes a removal position within the cargo space, which is accessible directly via the loading/unloading opening and from which the locker cabinet to be delivered immediately has been removed from the cargo space. This movement of the locker cabinets in the cargo space can have a plurality of movement steps. For example, in a first movement step, locker cabinets which adjoin the removal position in a row, in particular a straight row, in the longitudinal direction of the cargo space can be moved individually or jointly in the direction of the loading/unloading opening of the cargo space. In a subsequent movement step, a locker cabinet adjoining the moved row in the delivery sequence can be moved in the transverse direction of the cargo space, with the result that this locker cabinet extends or completes the moved row. For carrying out this transverse movement of the locker cabinet within the cargo space, the cargo space can have a lateral cargo space access door. In a final movement step, locker cabinets which are arranged in a further row arranged parallel to the moved row in the longitudinal direction of the cargo space can be moved individually or jointly away from the loading/unloading opening of the cargo space. To automate the movement of the locker cabinets in the cargo space, the delivery vehicle can be provided with a movement device.

According to a further advantageous embodiment, an empty locker cabinet is arranged in such a way in the cargo space, at a loading position within the cargo space which has become free as a result of the movement of the remaining locker cabinets located in the cargo space, while maintaining the delivery sequence, and which is accessible directly via the loading/unloading opening, that the delivery sequence is extended at the end by the empty locker cabinet. In this way, a locker loaded with postal items can be exchanged for an empty locker, in particular at a single automatic parcel station. The arrangement of the empty locker cabinet at the loading position can take place in such a way that the locker cabinets which, as described above, are arranged in a further row arranged parallel to the moved row in the longitudinal direction of the cargo space are moved or displaced jointly away from the loading/unloading opening of the cargo space by progressive insertion of the empty locker cabinet into the cargo space. Alternatively, the movement of this row can take place before the insertion of the empty locker cabinet into the cargo space.

According to a further advantageous embodiment, the locker cabinets loaded with postal items are arranged in a U-shaped delivery sequence within the cargo space. This makes possible compact arrangement and simple movement of the locker cabinets in the cargo space.

According to a further advantageous embodiment, the locker cabinets are moved within the cargo space and/or removed from the cargo space and/or inserted into the cargo space by means of a mobile transport unit. As a result, the movement and/or removal and/or insertion can take place at least partially automatically, significantly simplifying the work involved in handling the locker cabinets. The mobile transport unit can have running wheels and a travel drive. The mobile transport unit can, for example, be moved partially under a locker cabinet to be moved, which can then be lifted by means of the mobile transport unit and then moved.

According to a further advantageous embodiment, the locker cabinets are moved within the cargo space and/or removed from the cargo space and/or inserted into the cargo space by means of their own running wheels and by means of their own travel drive. In this case, a mobile transport unit of the kind described above can be dispensed with. Nevertheless, the movement and/or removal and/or insertion can take place at least partially automatically in this context, significantly simplifying the work involved in handling the locker cabinets. The respective locker cabinet can have at least one steerable running wheel.

According to a further advantageous embodiment, the locker cabinets are moved within the cargo space and/or removed from the cargo space and/or inserted into the cargo space by means of their own running wheels and manually. This manual handling of the locker cabinets can take place with a relatively low expenditure of force because of the running wheels.

The above object is furthermore achieved by means of a system having the features of a system in accordance with the invention, which is designed for carrying out the method according to one of the abovementioned embodiments or a combination of at least two of these embodiments with one another.

The advantages mentioned above in respect of the method are correspondingly associated with the system. The delivery vehicle can be, for example, a utility vehicle, in particular also an autonomous utility vehicle.

According to an advantageous embodiment, the system has at least one mobile transport unit for moving the locker cabinets within the cargo space and/or for removing in each case one locker cabinet from the cargo space and/or for inserting in each case one locker cabinet into the cargo space. The advantages mentioned above in respect of the corresponding embodiment of the method are correspondingly associated with this embodiment.

According to a further advantageous embodiment, the delivery vehicle has a rear lift gate and/or a front lateral cargo space access door. By means of the lift gate, the handling of locker cabinets to be unloaded and loaded is significantly simplified. To move the locker cabinets in the cargo space, it is possible to access the cargo space via the cargo space access door.

### BRIEF DESCRIPTION OF THE DRAWINGS

Further advantageous embodiments of the invention are disclosed in the dependent claims and the following description of the figures, of which:

FIG. 1 shows a schematic illustration from the side of an exemplary embodiment for a system according to the invention,

FIG. 2 shows a schematic illustration of the system shown in FIG. 1 from above in a state of a delivery and collection operation,

FIG. 3 shows a schematic illustration of the system shown in FIG. 1 from above in a further state of the delivery and collection operation,

FIG. 4 shows a schematic illustration of the system shown in FIG. 1 from above in a further state of the delivery and collection operation,

FIG. 5 shows a schematic illustration of the system shown in FIG. 1 from above in a further state of the delivery and collection operation,

FIG. 6 shows a schematic illustration of the system shown in FIG. 1 from above in a further state of the delivery and collection operation,

FIG. 7 shows a schematic illustration of the system shown in FIG. 1 from above in a further state of the delivery and collection operation,

FIG. 8 shows a schematic illustration of the system shown in FIG. 1 from above in a further state of the delivery and collection operation, and

FIG. 9 shows a schematic illustration from the side of a further exemplary embodiment for a system according to the invention.

In the different figures, identical parts are always provided with the same reference signs, for which reason they are generally also only described once.

### DETAILED DESCRIPTION

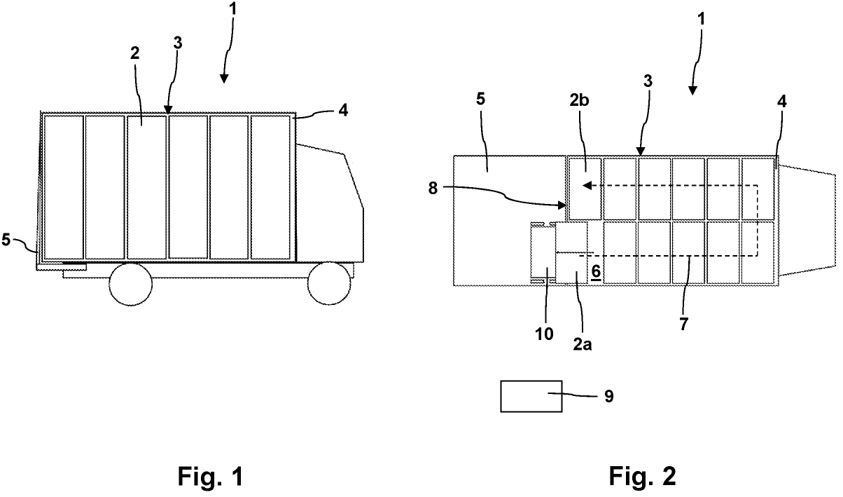

FIG. 1 shows a schematic side illustration of an exemplary embodiment for a system 1 according to the invention for delivering mobile locker cabinets 2 loaded with postal items to automatic parcel stations and for collecting empty mobile locker cabinets (shown in FIGS. 2 to 8) from automatic parcel stations.

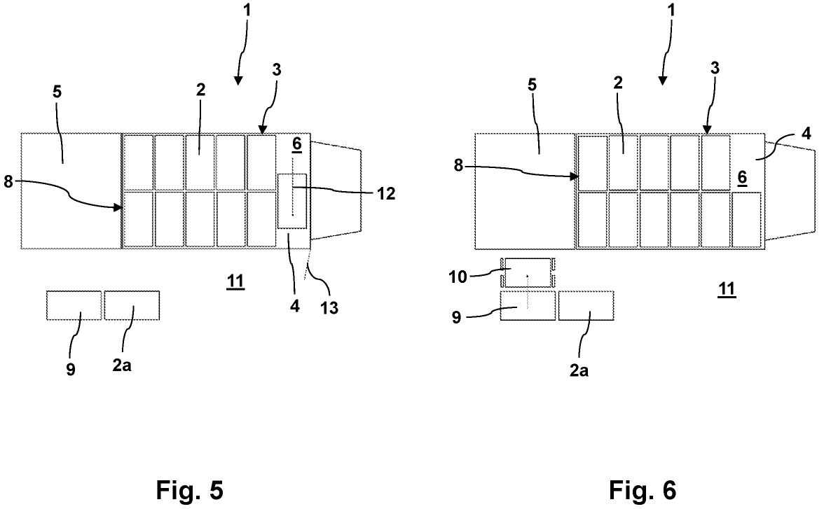

The system 1 has a delivery vehicle 3 in the form of a utility vehicle with a cargo space 4 for accommodating mobile locker cabinets 2. The delivery vehicle 3 has a rear lift gate 5 and a front lateral cargo space access door shown in FIG. 4.

Moreover, the system 1 has a mobile transport unit, shown in FIGS. 2 to 4 and 6 to 9, for moving the locker cabinets 2 within the cargo space 4, for removing in each case one locker cabinet 2 from the cargo space 4 and for inserting in each case one locker cabinet 2 into the cargo space 4.

FIG. 2 shows a schematic illustration of the system 1 shown in FIG. 1 from above in a state of a delivery and collection operation. FIG. 2 shows that, depending on a delivery route, the locker cabinets 2 loaded with postal items have been arranged in a U-shaped delivery sequence, indicated by an arrow 7, within the cargo space 4 in such a way that a locker cabinet 2a which forms a start of the delivery sequence and a locker cabinet 2b which forms an end of the delivery sequence are accessible directly via a rear loading/unloading opening 8 of the cargo space 4. The delivery vehicle 3 is parked in the region of an automatic parcel station, of which only an empty locker cabinet 9 is shown.

In order to produce the state shown in FIG. 2, the lift gate 5 has been brought into a functional position aligned with a floor 6 of the cargo space 4. Moreover, the locker cabinet 2a forming the start of the delivery sequence has been moved partially out of its removal position, which is accessible directly via the loading/unloading opening 8, by means of the mobile transport unit 10, in order to move this locker cabinet 2a onto the lift gate 5.

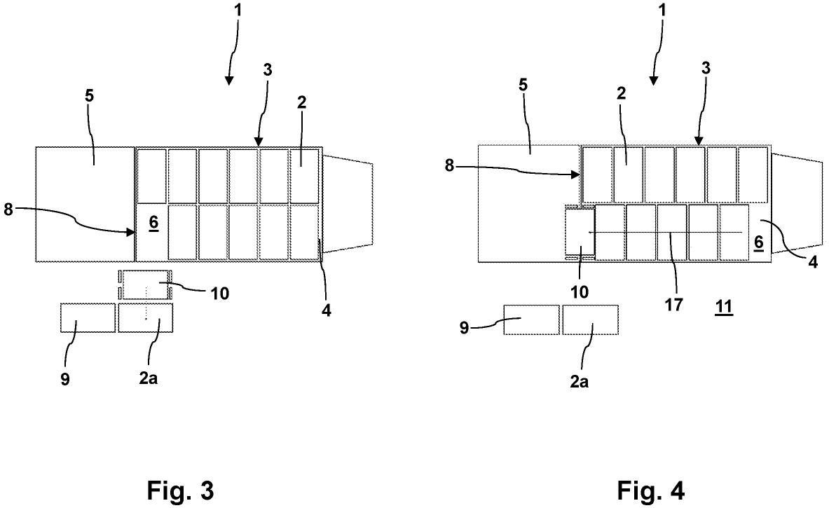

FIG. 3 shows a schematic illustration of the system 1 shown in FIG. 1 from above in a further state of the delivery and collection operation. This state is derived from the state shown in FIG. 2 in that the locker cabinet 2a has been set down on the floor 11 by means of the lift gate 5 and the mobile transport unit 10.

FIG. 4 shows a schematic illustration of the system 1 shown in FIG. 1 from above in a further state of the delivery and collection operation. This state is derived from the state shown in FIG. 3 in that the mobile transport unit 10 has been moved back into the cargo space 4 with the aid of the lift gate 5 and in that five locker cabinets 2 arranged in a straight line have been moved jointly in the direction of the loading/unloading opening 8 of the cargo space 4 by means of the mobile transport unit 10 in accordance with the arrow 17.

FIG. 5 shows a schematic illustration of the system 1 shown in FIG. 1 from above in a further state of the delivery and collection operation. This state is derived from the state shown in FIG. 4 in that the five locker cabinets 2 arranged in a straight line have been moved jointly by means of the mobile transport unit 10 in the direction of the loading/unloading opening 8 of the cargo space 4 in such a way that the locker cabinet 2 to be delivered next assumes the removal position within the cargo space 4, which is accessible directly via the loading/unloading opening 8 and from which the locker cabinet 2a to be delivered immediately has been removed from the cargo space 4. Subsequently, a locker cabinet 2 adjoining the displaced row in the delivery sequence has been moved in the transverse direction of the cargo space 4 in accordance with the arrow 12, with the result that this locker cabinet 2 extends or completes the displaced row at the front. For carrying out this transverse movement of the locker cabinet 2 within the cargo space 4, the cargo space 4 has a lateral cargo space access door 13.

FIG. 6 shows a schematic illustration of the system 1 shown in FIG. 1 from above in a further state of the delivery and collection operation. This state is derived from the state shown in FIG. 5 in that the mobile transport unit 10 has been moved to the empty locker cabinet 9 in order to insert the empty locker cabinet 9 into the cargo space 4.

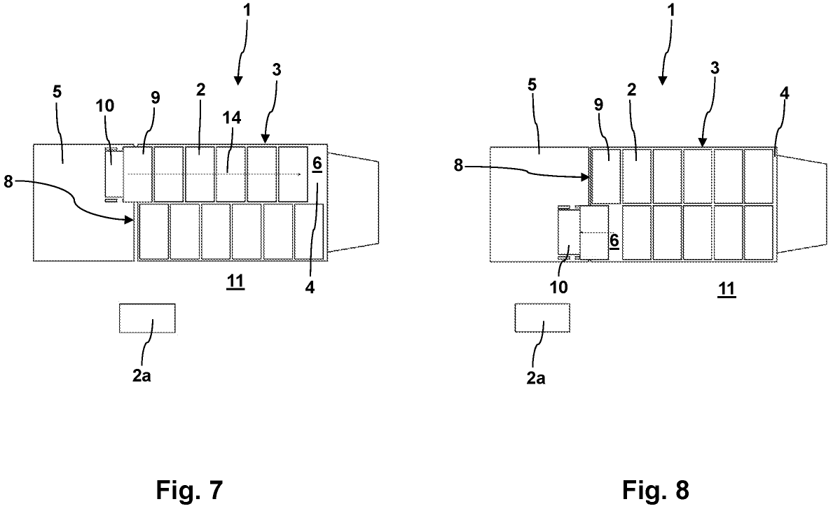

FIG. 7 shows a schematic illustration of the system 1 shown in FIG. 1 from above in a further state of the delivery and collection operation. This state is derived from the state shown in FIG. 6 in that the empty locker cabinet 9 has been partially inserted into the cargo space 4 by means of the mobile transport unit 10, whereby a series of five locker cabinets 2 has been pushed away jointly from the loading/unloading opening 8 in accordance with the arrow 14.

FIG. 8 shows a schematic illustration of the system 1 shown in FIG. 1 from above in a further state of the delivery and collection operation. This state is derived from the state shown in FIG. 7 in that the row of five locker cabinets 2 has been completely pushed away jointly from the loading/unloading opening 8, with the result that the empty locker cabinet 9 has been arranged in such a way within the cargo space 4, at a loading position which has become free as a result of this movement and is accessible directly via the loading/unloading opening 8, that the delivery sequence is extended or completed at the end by the empty locker cabinet 9. Subsequently, the mobile transport unit 10 has been moved to the locker cabinet 2 which is to be delivered next and this locker cabinet 2 has been moved partially out of the cargo space 4, with the result that the state corresponds substantially to the state from FIG. 2 and it is thus possible to repeat the steps described above in order to deliver at least one further locker cabinet 2 and to collect at least one further empty locker cabinet 9.

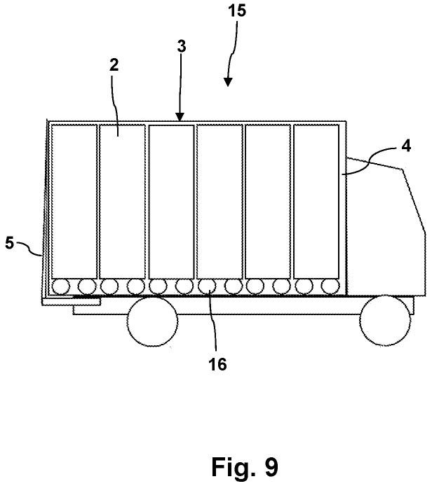

FIG. 9 shows a schematic side illustration of a further exemplary embodiment for a system 15 according to the invention for delivering mobile locker cabinets 2 loaded with postal items to automatic parcel stations and for collecting empty mobile locker cabinets (shown in FIGS. 2 to 8) from automatic parcel stations.

The system 15 differs from the exemplary embodiment shown in FIGS. 1 to 8 solely in that the locker cabinets 2 each have running wheels 16 and a travel drive (not shown), thus enabling the above-described delivery and collection operation to be carried out without a mobile transport unit. To avoid repetition, attention is drawn in other respects to the above description of FIGS. 1 to 8.

### LIST OF REFERENCE SYMBOLS

1 system
2 locker cabinet
2a locker cabinet (start)
2b locker cabinet (end)
3 delivery van
4 cargo space
5 lift gate
6 floor of 4
7 arrow (delivery sequence)
8 loading/unloading opening of 4
9 empty locker cabinet
10 mobile transport unit
11 floor
12 arrow (transverse movement)
13 lateral cargo space access door of 4
14 arrow (row movement)
15 system
16 running wheel of 2
17 arrow (row movement)

1. Method for delivering mobile locker cabinets loaded with postal items to automatic parcel stations and for collecting empty mobile locker cabinets from automatic parcel stations by means of a delivery vehicle having a cargo space, comprising:
depending on a delivery route, loading the locker cabinets with postal items are arranged in a delivery sequence within the cargo space in such a way that a locker cabinet which forms a start of the delivery sequence and a locker cabinet which forms an end of the delivery sequence are accessible directly via a rear loading/unloading opening of the cargo space.

2. Method according to claim 1, further comprising:
after removal of a locker cabinet to be delivered immediately from the cargo space, moving in the cargo space the remaining locker cabinets located in the cargo space in such a way, while maintaining the delivery sequence, that the locker cabinet to be delivered next assumes a removal position within the cargo space, which is accessible directly via the loading/unloading opening and from which the locker cabinet to be delivered immediately has been removed from the cargo space.

3. Method according to claim 2, further comprising:
arranging an empty locker cabinet in such a way in the cargo space, at a loading position within the cargo space which has become free as a result of the movement of the remaining locker cabinets located in the cargo space, while maintaining the delivery sequence, and which is accessible directly via the loading/unloading opening, that the delivery sequence is extended at the end by the empty locker cabinet.

4. Method according to claim 1, comprising:
arranging the locker cabinets loaded with postal items in a U-shaped delivery sequence within the cargo space.

5. Method according to claim 1, comprising at least one of:
moving within the cargo space the locker cabinets by means of a mobile transport unit;
removing from the cargo space the locker cabinets by means of a mobile transport unit; or
inserting into the cargo space the locker cabinets by means of a mobile transport unit.

6. Method according to claim 1, comprising:
moving the locker cabinets within the cargo space by means of their own running wheels and by means of their own travel drive;
removing the locker cabinets from the cargo space by means of their own running wheels and by means of their own travel drive; or
inserting the locker cabinets into the cargo space by means of their own running wheels and by means of their own travel drive.

7. Method according to claim 1, comprising:
moving the locker cabinets within the cargo space manually;
removing the locker cabinets from the cargo space manually; or
inserting the locker cabinets into the cargo space manually.

8. A system for delivering mobile locker cabinets loaded with postal items to automatic parcel stations and for collecting empty mobile locker cabinets from automatic parcel stations, comprising:
at least one delivery vehicle having a cargo space for accommodating mobile locker cabinets; and
a plurality of mobile locker cabinets for accommodating postal items, wherein the system is designed to carry out the method according to any of the preceding claims.

9. System according to claim 8, comprising:
at least one mobile transport unit for moving the locker cabinets within the cargo space and/or for removing in each case one locker cabinet from the cargo space and/or for inserting in each case one locker cabinet into the cargo space.

10. System according to claim 8, comprising:
the delivery vehicle has a rear lift gate and/or a front lateral cargo space access door.
